(19) United States
(12) Patent Application Publication
(10) Pub. No.: US 2013/0208401 A1
(43) Pub. Date: Aug. 15, 2013

(54) ELECTRONIC COMPONENT AND METHOD FOR MANUFACTURING ELECTRONIC COMPONENT

(71) Applicant: TDK Corporation, (US)

(72) Inventors: Yukihiko SHIRAKAWA, Tokyo (JP); Yasuhito TAKAMATSU, Tokyo (JP); Osamu HIROSE, Tokyo (JP); Kazuhiro NAKAMURA, Tokyo (JP); Daisuke HIROTA, Tokyo (JP)

(73) Assignee: TDK CORPORATION, Tokyo (JP)

(21) Appl. No.: 13/757,058

(22) Filed: Feb. 1, 2013

(30) Foreign Application Priority Data
Feb. 10, 2012 (JP) 2012-027535

(51) Int. Cl. H01G 13/06; H01G 4/008

(52) U.S. Cl. CPC H01G 13/06; H01G 4/008
USPC 361/305; 216/13

(57) ABSTRACT

An electronic component has an element body and an external electrode arranged on the element body. The element body has a pair of end faces opposed to each other, a pair of principal faces opposed to each other, and a pair of side faces opposed to each other. The external electrode is formed so as to cover the end face and a partial region of the principal face and/or a partial region of the side face. The external electrode has a thick film electrode, a thin film electrode, and a plated layer. The thick film electrode is formed on the end face. The thin film electrode is formed so as to cover the thick film electrode and the partial region of the principal face and/or the partial region of the side face. The plated layer is formed outside the thin film electrode and contains Sn or an Sn alloy.

### BACKGROUND OF THE INVENTION

1. Field of the Invention

The present invention relates to an electronic component and a method for manufacturing the electronic component.

2. Related Background Art

As a method of forming an external electrode of an electronic component, there is a known method including a step of forming an electroconductive coating on a capacitor element by a plasma sputtering process, a step of forming a protective coating of a resist material on a terminal portion of the capacitor element with the electroconductive coating thereon, a step of removing the electroconductive coating from the region other than the terminal portion by etching, and, thereafter, a step of removing the resist (e.g., of Japanese Patent Application Laid-open No. H01-152712). Another known external electrode forming method is one including applying an electroconductive paste onto a main body of the electronic component and sintering it to form a first electrode layer, and thereafter successively forming coatings of a second electrode layer of Ni and a third electrode layer of Sn on the first electrode layer by sputtering, vacuum evaporation, or plasma spraying (e.g., cf. Japanese Patent Application Laid-open No. S60-236207)

### SUMMARY OF THE INVENTION

The external electrode forming method described in Japanese Patent Application Laid-open No. H01-152712 has problems as described below.

The electroconductive coating is formed directly on the capacitor element by plasma sputtering. For this reason, there is a possibility of causing the following defect. The foregoing configuration can fall to achieve sufficient electrical connection between the electroconductive coating and internal electrodes and sufficient adherence strength of the electroconductive coating to the capacitor element. If there is a microscopic foreign substance on an end face, the electroconductive coating will not be formed on a place where the foreign substance exits. If the electroconductive coating is not appropriately formed on the end face where the internal electrodes are exposed, a plating solution will infiltrate through the end face into the capacitor element during formation of a plated layer thereon, and the infiltrating plating solution will degrade characteristics of the electronic component.

The etching method applied is a wet etching process using a chlorine-based etchant. In the wet etching process, the etchant can damage the capacitor element itself as the foregoing plating solution can. Particularly, when infiltrating into the capacitor element through a defective portion of the resist or through a defective portion of the capacitor element, the etchant can significantly adversely affect the capacitor element. Since the electroconductive coating is comprised of an Ni—Cr alloy, it is impossible to apply a plasma etching process as the etching method.

The external electrode forming method described in Japanese Patent Application Laid-open No. S60-236207 also has problems as described below.

The second electrode layer is comprised of Ni and the third electrode layer is comprised of Sn. Ni and Sn are inferior in efficiency of formation of thin film by sputtering and low in productivity, and therefore they are less likely to be realized. As for etching, it is impossible to apply the plasma etching process and it is thus inevitable to apply the wet etching process. Since the first electrode layer is formed on an end face of the main body of the electronic component and four faces adjacent to the end face, the size of the external electrode becomes large, which inhibits downsizing of the electronic component.

An object of the present invention is to provide an electronic component capable of preventing the characteristic degradation while achieving downsizing of the external electrode, and a method for manufacturing the electronic component.

An aspect of the present invention is an electronic component comprising: an element body having a pair of end faces opposed to each other, a pair of principal faces extending so as to connect the pair of end faces and opposed to each other, and a pair of side faces extending so as to connect the pair of principal faces and opposed to each other; and an external electrode arranged on the element body and formed so as to cover the and face and a partial region of the principal face and/or a partial region of the side face, wherein the external electrode has: a thick film electrode formed on the end face; a thin film electrode formed so as to cover the thick film electrode and the partial region of the principal surface and/or the partial region of the side face; and a plated layer formed outside the thin film electrode and containing Sn or an Sn alloy.

In the present invention, the thick film electrode is formed on the end face of the element body. The electronic component, in general, has an internal conductor arranged in the element body and exposed in the end face, and the internal conductor is connected to the thick film electrode. For this reason, the electrical connection between the internal conductor and the thick film electrode and the adherence strength of the thick film electrode to the element body are ensured at a necessary and sufficient level. The thick film electrode is formed substantially on the end face and the thin film electrode is formed on the partial region of the principal face and/or on the partial region of the side face adjacent to the end face. This configuration drastically reduces the size of the portion of the external electrode located on the principal face and/or the side face of the element body. As a consequence, the electronic component can be realized in a compact size. The thick film electrode and the thin film electrode formed thereon are located on the end face of the element body, and in formation of the plated layer, they prevent the plating solution from infiltrating through the end face into the element body. Therefore, this configuration can prevent the degradation of characteristics of the electronic component.

The thin film electrode may be comprised of tungsten (W). Tungsten is, generally, an electroconductive material that has strong adhesion to the element body comprised of oxide and sufficient resistance to corrosion with the plating solution and that can be dry-etched. Therefore, the thin film electrode is highly adhesive to the element body at the portion located on the principal face and/or the side face of the element body and thus the adherence strength of the thin film electrode to the element body can be ensured at a necessary and sufficient level. The thin film electrode is also prevented from being corroded by the plating solution during the formation of the plated layer.

The film thickness of the thin film electrode may be not more than 0.2 μm. In this case, the size of the external electrode can be more drastically reduced. Even if the film thickness of the thin film electrode is not more than 0.2 μm, the thin film electrode can fully function as a seed layer in the formation of the plated layer. Since the thin film electrode can be extremely thin, it is easy to form the thin film electrode, which can reduce production requirements and cost.

The thick film electrode may have a sintered electrode layer and a plated layer formed on the sintered electrode layer. In this case, a configuration with substantially uniform thickness and with few defects is realized as a configuration of the thick film electrode.

Another aspect of the present invention is a method for manufacturing an electronic component, comprising: an element body preparation step of preparing an element body having a pair of end faces opposed to each other, a pair of principal faces extending so as to connect the pair of end faces and opposed to each other, and a pair of side faces extending so as to connect the pair of principal faces and opposed to each other; and an external electrode forming step of forming an external electrode so as to cover the end face and a partial region of the principal face and/or a partial region of the side face, on the element body, wherein the external electrode forming step includes: a step of forming a thick film electrode on the end face; a step of forming an electroconductive thin film on the thick film electrode and on the principal face and/or the side face by a vacuum film formation method; a step of forming a resist layer on an intended area of formation of the external electrode on the electroconductive thin film; a step of removing the electroconductive thin film not covered by the resist layer, by an etching method; a step of peeling off the resist layer and a step of forming a plated layer containing Sn or an Sn alloy, after peeling off the resist layer.

In the present invention, the thick film electrode is formed on the end face of the element body. The electronic component, in general, has an internal conductor arranged in the element body and exposed in the end face, and the internal conductor is connected to the thick film electrode. For this reason, the electrical connection between the internal conductor and the thick film electrode and the adherence strength of the thick film electrode to the element body are ensured at a necessary and sufficient level. Through the step of forming the electroconductive thin film, the step of forming the resist layer, the step of removing the electroconductive thin film not covered by the resist layer, and the step of peeling off the resist layer, the electroconductive thin film is formed so as to cover the thick film electrode and the partial region of the principal face and/or the partial region of the side face and the electroconductive thin film function as a thin film electrode. The thick film electrode is formed substantially on the end face and the electroconductive thin film is formed on the partial region of the principal face and/or on the partial region of the side face adjacent to the end face. This configuration drastically reduces the size of the portion of the external electrode located on the principal face and/or the side face of the element body. As a consequence, the electronic component can be realized in a compact size. The thick film electrode and the electroconductive thin film formed thereon are located on the end face of the element body, and in formation of the plated layer, they prevent the plating solution from infiltrating through the end face into the element body. Therefore, this configuration can prevent the degradation of characteristics of the electronic component.

The step of forming the electroconductive thin film may comprise forming the electroconductive thin film of tungsten. Tungsten is, generally, an electroconductive material that has strong adhesion to the element body comprised of oxide and sufficient resistance to corrosion with the plating solution and that can be dry-etched. Therefore, the electroconductive thin film (thin film electrode) is highly adhesive to the element body at the portion located on the principal face and/or the side face of the element body and thus the adherence strength of the electroconductive thin film to the element body can be ensured at a necessary and sufficient level. The electroconductive thin film is prevented from being corroded by the plating solution during the formation of the plated layer. Particularly, the plasma etching process is applicable to the removal of the electroconductive thin film not covered by the resist layer, which allows easy and simple execution of the removal of the electroconductive thin film.

The step of forming the electroconductive thin film may comprise forming the electroconductive thin film in the film thickness of not more than 0.2 μm. In this case, the size of the external electrode can be more drastically reduced. Even if the film thickness of the electroconductive thin film is not more than 0.2 μm, the electroconductive thin film can fully function as a seed layer in the formation of the plated layer. Since the electroconductive thin film can be extremely thin, it is easy to form the electroconductive thin film, which can reduce production requirements and cost. The electroconductive thin film not covered by the resist layer can be removed in a short time because it is thin.

The step of forming the thick film electrode may comprise forming a sintered electrode layer by sintering of an electroconductive paste, and forming a plated layer on the sintered electrode layer. In this case, a configuration with substantially uniform thickness and with few defects is realized as a configuration of the thick film electrode.

The present invention will become more fully understood from the detailed description given hereinbelow and the accompanying drawings which are given by way of illustration only, and thus are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a perspective view showing an electronic component according to an embodiment of the present invention.

FIG. 2 is a drawing for explaining a sectional configuration of the electronic component according to the embodiment.

FIG. 3 is a drawing for explaining a method for manufacturing the electronic component according to the embodiment.

FIG. 4 is a drawing for explaining the method for manufacturing the electronic component according to the embodiment.

FIG. 5 is a drawing for explaining a sectional configuration of an electronic component according to a modification example of the embodiment.

### DESCRIPTION OF THE PREFERRED EMBODIMENTS

The preferred embodiments of the present invention will be described below in detail with reference to the accompanying drawings. In the description, the same elements or elements with the same functionality will be denoted by the same reference signs, without redundant description.

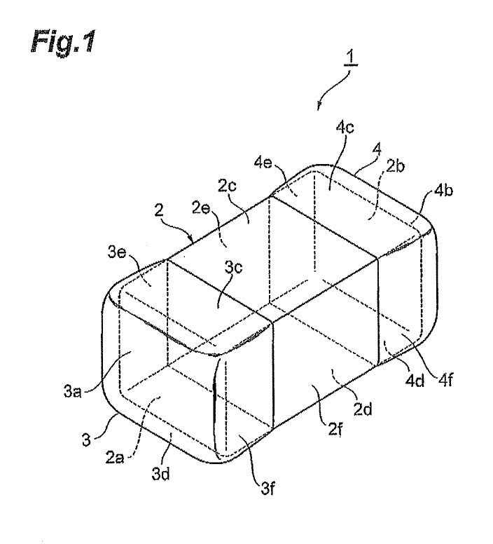

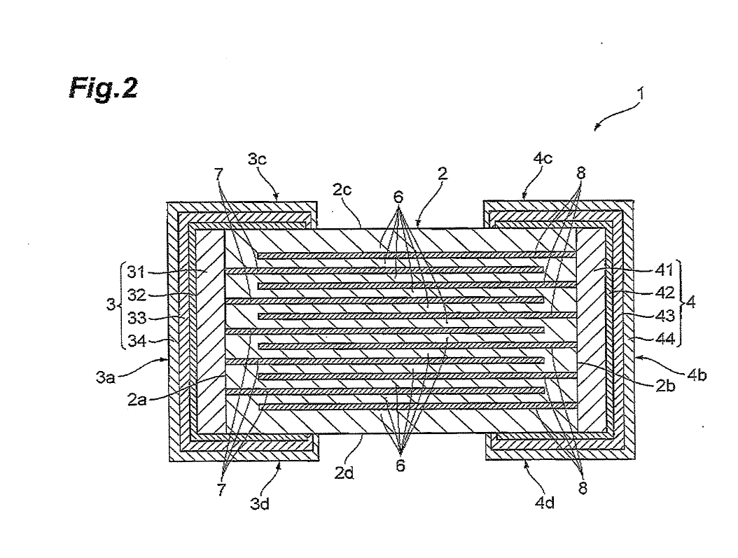

A configuration of an electronic component 1 according to an embodiment of the present invention will be described with reference to FIGS. 1 and 2. FIG. 1 is a perspective view showing the electronic component of the present embodiment. FIG. 2 is a drawing for explaining the sectional configuration of the electronic component of the present embodiment.

The electronic component 1 is, for example, an electronic component such as a multilayer ceramic capacitor and is provided with an element body 2 and a plurality of external electrodes 3, 4. The element body 2 is constructed in a nearly rectangular parallelepiped shape by laminating and integrating a plurality of ceramic green sheets. The element body 2, as also shown in FIG. 1, has a pair of end faces 2a, 2b, a pair of principal faces 2c, 2d, and a pair of side faces 2e, 2f. The pair of end faces 2a, 2b are opposed to each other in the longitudinal direction of the element body 2. The pair of principal faces 2c, 2d extend so as to connect the pair of end faces 2a, 2b and are opposed to each other. The pair of side faces 2e, 2f extend so as to connect the pair of principal faces 2c, 2d and are opposed to each other.

The electronic component 1 is set, for example, in such dimensions that the longitudinal length falls in the range of about 0.4 mm to 1.6 mm, the lateral width in the range of about 0.2 mm to 0.8 mm, and the thickness in the range of about 0.4 mm to 0.8 mm.

The element body 2, as shown in FIG. 2, is constructed as a multilayer body in which there are a plurality of rectangular dielectric layers 6 and a plurality of internal electrodes 7 and 8 laminated together. The internal electrodes 7 and the internal electrodes 8 are alternately arranged layer by layer along a lamination direction of the dielectric layers 6 (which will be referred to hereinafter simply as “lamination direction”) in the element body 2. The internal electrodes 7 and the internal electrodes 8 are arranged opposite to each other with at least one dielectric layer 6 in between two internal electrodes 7 and 8.

Each dielectric layer 6 is comprised of a sintered body of a ceramic green sheet, for example, containing a dielectric ceramic (dielectric ceramic such as BaTIO₃, Ba(Ti,Zr)O₃, or (Ba,Ca)TiO₃ type ceramic). In a practical form of the element body 2, the dielectric layers 6 are integrally formed so that no boundary can be visually recognized between the dielectric layers 6.

The internal electrodes 7, 8 contain an electroconductive material (e.g., Ni, Ag, Pd, an Ag—Pd alloy, or Cu). The thickness of the internal electrodes 7, 8 is, for example, in the range of about 0.5 μm to 3 μm. There are no particular restrictions on the shape of the internal electrodes 7, 8 as long as they are shaped so as to have mutually overlapping regions when viewed from the lamination direction. The internal electrodes 7, 8 are formed, for example, in a rectangular shape. Each of the internal electrodes 7, 8 is constructed as a sintered body of an electroconductive paste containing the aforementioned electroconductive material. The internal electrodes 7 are electrically and physically connected to the external electrode 3, while the internal electrodes 8 are electrically and physically connected to the external electrode 4.

The external electrode 3 is formed on the end face 2a side of the element body 2. The external electrode 3 is formed so as to cover one end face 2a, and partial regions of respective edge portions of the two principal faces 2c, 2d and the two side faces 2e, 2f perpendicular to the end face 2a. Namely, the external electrode 3 has an electrode portion 3a located on the end face 2a, electrode portions 3c, 3d located on the partial regions of the respective principal faces 2c, 2d, and electrode portions 3e, 3f located on the partial regions of the respective side faces 2e, 2f. In the present embodiment the external electrode 3 has the five-face electrode structure.

The external electrode 3 has a thick film electrode 31, a thin film electrode 32, a first plated layer 33, and a second plated layer 34. The thick film electrode 31 is formed on the end face 2a. The thin film electrode 32 is formed so as to cover the thick film electrode 31 and the partial regions of the respective edge portions of the two principal faces 2c, 2d and the two side faces 2e, 2f. The first plated layer 33 is formed so as to cover the thin film electrode 32. The second plated layer 34 is formed so as to cover the first plated layer 33. Namely, the second plated layer 34 is formed outside the thin film electrode 32.

The electrode portion 3a includes the thick film electrode 31, a portion of the thin film electrode 32 located corresponding to the end face 2a, and portions of the first and second plated layers 33, 34 located corresponding to the end face 2a. The electrode portion 3c includes a portion of the thin film electrode 32 located corresponding to the principal face 2c, and portions of the first and second plated layers 33, 34 located corresponding to the principal face 2c. The electrode portion 3d includes a portion of the thin film electrode 32 located corresponding to the principal face 2d, and portions of the first and second plated layers 33, 34 located corresponding to the principal face 2d. The electrode portion 3e includes a portion of the thin film electrode 32 located corresponding to the side face 2e, and portions of the first and second plated layers 33, 34 located corresponding to the side face 2e. The electrode portion 3f includes a portion of the thin film electrode 32 located corresponding to the side face 2f, and portions of the first and second plated layers 33, 34 located corresponding to the side face 2f.

The external electrode 4 is formed on the end face 2b side of the element body 2. The external electrode 4 is formed so as to cover the other end face 2b, and partial regions of respective edge portions of the two principal faces 2c, 2d and the two side faces 2e, 2f perpendicular to the end face 2b. Namely, the external electrode 4 has an electrode portion 4b located on the end face 2b, electrode portions 4c, 4d located on the partial regions of the respective principal faces 2c, 2d, and electrode portions 4e, 4f located on the partial regions of the respective side faces 2e, 2f. In the present embodiment the external electrode 4 has the five-face electrode structure.

The external electrode 4 also has a thick film electrode 41, a thin film electrode 42, a first plated layer 43, and a second plated layer 44 as the external electrode 3 does. The thick film electrode 41 is formed on the end face 2b. The thin film electrode 42 is formed so as to cover the thick film electrode 41 and the partial regions of the respective edge portions of the two principal faces 2c, 2d and the two side faces 2e, 2f. The first plated layer 43 is formed so as to cover the thin film electrode 42. The second plated layer 44 is formed so as to cover the first plated layer 43. Namely, the second plated layer 44 is formed outside the thin film electrode 42.

The electrode portion 4b includes the thick film electrode 41, a portion of the thin film electrode 42 located corresponding to the end face 2b, and portions of the first and second plated layers 43, 44 located corresponding to the end face 2b. The electrode portion 4c includes a portion of the thin film electrode 42 located corresponding to the principal face 2c, and portions of the first and second plated layers 43, 44 located corresponding to the principal face 2c. The electrode portion 4d includes a portion of the thin film electrode 42 located corresponding to the principal face 2d, and portions of the first and second plated layers 43, 44 located corresponding to the principal face 2d. The electrode portion 4e includes a portion of the thin film electrode 42 located corresponding to the side face 2e, and portions of the first and second plated layers 43, 44 located corresponding to the side face 2e. The electrode portion 4f includes a portion of the thin film electrode 42 located corresponding to the side face 2f, and portions of the first and second plated layers 43, 44 located corresponding to the side face 2f.

Each of the thick film electrodes 31, 41 is formed, as described below, by applying an electroconductive paste containing a metal powder, glass frit, and organic vehicle onto the corresponding end face 2a, 2b and then sintering it at a predetermined temperature (e.g., approximately 700° C.). Namely, in the present embodiment, each thick film electrode 31, 41 consists of a sintered electrode layer. The metal powder to be used herein can be a powder of a metal such as Cu, Ni, Ag, or Pd. The thin film electrodes 32, 42 are formed by a below-described method and are comprised of tungsten. The first plated layers 33, 43 are formed, for example, by electroplating and are comprised of Ni or an Ni alloy. The second plated layers 34, 44 are formed, for example, by electroplating and are comprised of Sn or an Sn alloy. Namely, each external electrode 3, 4 has the plated layer containing Sn or the Sn alloy.

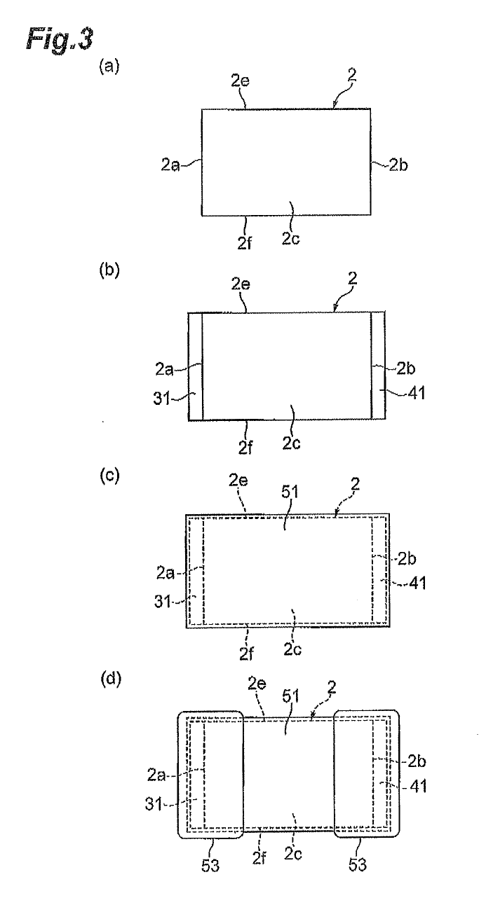

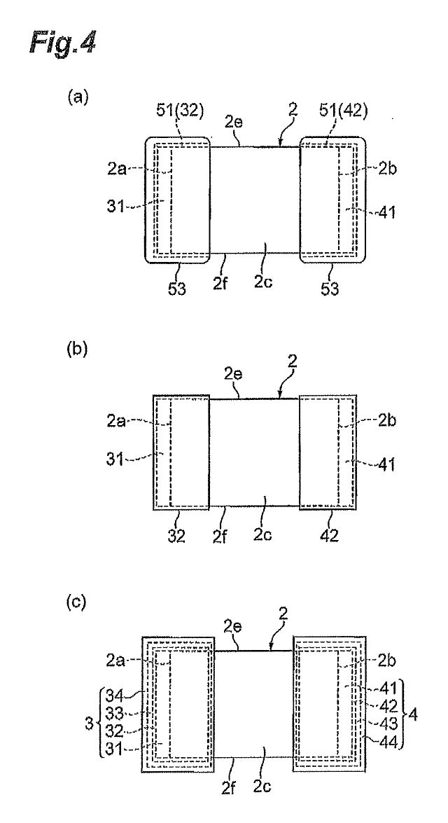

The below will describe a method for manufacturing the electronic component 1 according to the present embodiment, with reference to FIGS. 3 and 4. FIGS. 3 and 4 are drawings for explaining the method for manufacturing the electronic component according to the embodiment.

(Element Body Preparation Process)

The manufacturing process of electronic component 1 starts from an element body preparation process. The element body preparation process is to prepare the element body 2, as shown in (a) of FIG. 3.

First, ceramic green sheets for dielectric layers 6 are formed. Thereafter, electrode patterns are formed on the ceramic green sheets. The electrode patterns are formed by printing patterns corresponding to the shape of the internal electrodes 7, 8 with an electroconductive paste, and then dry it. The plurality of ceramic green sheets with the electrode patterns thereon are stacked to form a laminate body of the ceramic green sheets. Then the formed laminate body is cut into a plurality of chips of the desired size. Subsequently, water, a plurality of chips, and polishing media are put into a hermetically-closed rotary pot comprised of a material such as polyethylene, and this hermetically-closed rotary pot is rotated to chamfer the corners of the chips. The chips after the chamfering process are thermally treated at a predetermined temperature for a predetermined time to implement debindering thereof. After completion of the debindering process, the chips are further fired to obtain element bodies 2.

(External Electrode Forming Process)

An external electrode forming process is carried out as a next process. The external electrode forming process includes a thick film electrode forming process, an electroconductive thin film forming process, a resist layer forming process, an electroconductive thin film removing process, a resist layer peeling process, and a plated layer forming process.

First, the thick film electrode forming process is carried out. In the thick film electrode forming process, as shown in (b) of FIG. 3, the thick film electrodes 31, 41 are formed on the respective end faces 2a, 2b of the element body 2 prepared. The thickness of the thick film electrodes 31, 41 is, for example, in the range of about 5 μm to 30 μm.

The thick film electrodes 31, 41 are formed, as described above, by applying the electroconductive paste onto the end faces 2a, 2b and sintering the applied electroconductive paste. The electroconductive paste to be used herein can be an electroconductive paste (Cu paste) containing a Cu powder, glass frit, and organic vehicle. The Cu paste applied is thermally treated in a reducing atmosphere to produce the thick film electrodes 31, 41 as sintered electrodes. The application of the electroconductive paste can be implemented by a dipping process, a printing process, or a transfer process, which is known as a common technique.

The electroconductive paste does not always have to be applied onto each of the end faces 2a, 2b only. The electroconductive paste may be applied so as to wrap around the corners up onto the two principal faces 2c, 2d and the two side faces 2e, 2f. It is, however, preferable to minimize the wraparound of the electroconductive paste onto the two principal faces 2c, 2d and the two side faces 2e, 2f, in order to reduce the size of the external electrodes 3, 4. For this purpose, a dipping process with a screen mesh can be adopted for the application of the electroconductive paste. A printing process with a screen mesh provided with an opening in an area equal to the area of the end faces 2a, 2b can also be employed to minimize the wraparound of the electroconductive paste onto the principal faces 2c, 2d and the side faces 2e, 2f.

The dipping process with the screen mesh will be described below. First, the screen mesh is prepared. Then the screen mesh is mounted on a flat plate and a mesh cavity portion of the screen mesh is filled with the electroconductive paste. The thickness of the electroconductive paste corresponds to the spatial volume of the mesh cavity portion of the screen mesh, Thereafter, the end faces 2a, 2b are pushed against the electroconductive paste filled in the mesh cavity portion of the screen mesh, to apply the electroconductive paste onto the end faces 2a, 2b. At this time, the end faces 2a, 2b are kept apart from the flat plate by the screen mesh.

Next, the electroconductive thin film forming process is carried out. In the electroconductive thin film forming process, as shown in (c) of FIG. 3, an electroconductive thin film 51 is formed on the thick film electrodes 31, 41 and on the two principal faces 2c, 2d and the two side faces 2e, 2f by a vacuum film formation method. The thickness of the electroconductive thin film 51 is, for example, in the range of about 0.005 μm to 2 μm. The thickness of the electroconductive thin film 51 is preferably larger than 0 μm and not more than 0.2 μm.

In the present embodiment, the electroconductive thin film 51 is formed over the entire area of the element body 2 with the thick film electrodes 31, 41 formed thereon. It is noted that the electroconductive thin film 51 does not always have to be formed over the entire area of the element body 2 with the thick film electrodes 31, 41 formed thereon. For example, it is sufficient that the electroconductive thin film 51 be formed on regions including intended areas where the external electrodes 3, 4 are to be formed in the element body 2 (intended areas of formation).

A material for making up the electroconductive thin film 51 may be any material that can be etched by a dry etching process using a plasma; e.g., it can be Mo (molybdenum), Nb (niobium), Ta (tantalum), Ti (titanium), Zr (zirconium), or W (tungsten). Particularly, tungsten is preferred among those because it is easily plasma-etched. The vacuum film formation method to be employed can be, for example, sputtering, evaporation, or chemical vapor deposition (CVD). The sputtering to be employed can be a barrel sputtering process. When the barrel sputtering process is applied, the electroconductive thin film 51 can be formed over a plurality of element bodies 2 together, thereby achieving high productivity and reduction of cost.

Next, the resist layer forming process is carried out. In the resist layer forming process, as shown in (d) of FIG. 3, resist layers 53 are formed on the intended areas of formation of the external electrodes 3, 4 on the electroconductive thin film 51. The resist layers 53 are formed by applying a resist material onto the intended areas of formation and drying it. Portions of the electroconductive thin film located in the intended areas of formation are covered by the resist layers 53. The other portion of the electroconductive thin film 51 located outside the intended areas of formation is not covered by the resist layers 53 and is thus exposed from the resist layers 53. The thickness of the resist layers 53 may be the thickness enough to remain unremoved after etching in the electroconductive thin film removing step. The thickness of the resist layers 53 is, for example, in the range of about 1 μm to 20 μm.

The resist material to be used is preferably a resin or, a mixture of a resin and an inorganic material, which should be a material that can be readily peeled off with a solvent. Examples of resist materials applicable herein include photoresists used in manufacture of semiconductors and printed circuit boards, solvent-soluble resins such as acrylic, styrene, or ethyl cellulose, and materials obtained by mixing the foregoing resins with an inorganic filler. The present embodiment employs the electroconductive paste (Cu paste) used in the thick film electrode step, as the resist material. The resist material can be applied by the dipping process, printing process, or transfer process. When the resist material is, for example, the electroconductive paste having been used in the conventional formation of thick film electrode, we can use the dipping process known as a process of forming a terminal electrode, as it is. The use of the dipping process can increase productivity. When the resist material is one of the aforementioned solvent-soluble resins such as acrylic, styrene, or ethyl cellulose, and the materials obtained by mixing the foregoing resins with an inorganic filler, the dipping process can also be used similarly if the material is provided with viscoelasticity equivalent to that of the electroconductive paste having been used in the conventional formation of thick film electrode. Therefore, the productivity can also improve in this case.

Next, the electroconductive thin film removing process is carried out. The electroconductive thin film removing process is, as shown in (a) of FIG. 4, to remove the portion of the electroconductive thin film 51 not covered by the resist layers 53, by etching. The etching method to be employed herein can be a dry etching process using no etchant. The dry etching process to be applied herein can be, for example, a plasma etching process to expose a workpiece to a region in which an etching gas is activated by plasma, or a reactive ion etching (RIE) process to further apply an electric bias to the workpiece to expose it to ion bombardment in the plasma. The etching gas to be used herein can be a well-known chlorine-based, bromine-based, or fluorine-based gas according to a composition of the electroconductive thin film. Particularly, when tungsten with a good dry etching property is used as the material of the electroconductive thin film 51, the etching gas to be used is a fluorine (F)-based reactive gas (e.g., CF₄ gas or SF₆ gas). The F-based reactive gas is the well-known gas, which is high in safety, low in facility cost, and easy in processing of waste gas. Therefore, the plasma etching process allows high-efficiency and low-cost etching. A plasma etching system to be used can be a barrel type plasma etching system. In this case, a large number of element bodies can be uniformly etched together.

Portions of the electroconductive thin film 51 remaining unremoved form the thin film electrodes 32, 42. Therefore, the thickness of the thin film electrodes 32, 42 is the same as that of the electroconductive thin film 51. Specifically, the thickness of the thin film electrodes 32, 42 is, for example, in the range of about 0.005 μm to 2 μm. The thickness of the thin film electrodes 32, 42 is preferably not less than 0.01 μm and not more than 0.2 μm. Preferably, the thickness of the thin film electrodes 32, 42 should not be too small beyond the foregoing range, in order to maintain the effect as contact layers at a satisfactory level. Preferably, the thickness of the thin film electrodes 32, 42 should not be too large beyond the foregoing range, in order to avoid degradation of productivity due to a longer manufacturing time in film formation and in etching.

Next, the resist layer peeling process is carried out. The resist layer peeling process is, as shown in (b) of FIG. 4, to peel off the resist layers 53. This process results in exposing the portions of the electroconductive thin film 51 remaining unremoved, i.e., the thin film electrodes 32, 42. When the resist material used is the electroconductive paste (Cu paste), the peeling process of the resist layers 53 is implemented by removing the resist layers 53 with an organic solvent (e.g., acetone or toluene).

Next, the plated layer forming process is carried out. The plated layer forming process is, as shown in (c) of FIG. 4, to form the first plated layers 33, 43 and the second plated layers 34, 44. The first plated layers 33, 43 are formed on the surfaces of the thin film electrodes 32, 42 by the electroplating process. The thin film electrodes 32, 42 function as seed layers. The second plated layers 34, 44 are formed on the surfaces of the first plated layers 33, 43 by the electroplating process. The electroplating process to be employed herein can be a barrel plating process. In the barrel plating process, the element body 2 is immersed in a plating solution in a barrel and then the barrel is rotated to form a plated layer.

The first plated layers 33, 43 are Ni-plated or Ni alloy-plated layers to prevent reaction between sintered electrodes (thick film electrodes 31, 41) and solder in a mounting operation. The second plated layers 34, 44 are Sn-plated or Sn alloy-plated layers to improve solder wettability in the mounting operation. The thickness of the first plated layers 33, 43 is, for example, in the range of about 0.5 μm to 7 μm and the thickness of the second plated layers 34, 44, for example, in the range of about 3 μm to 8 μm.

The electronic component 1 with the element body 2 and the external electrodes 3, 4 is obtained through the external electrode forming process. It is optional to perform an electric property test and an appearance check after the external electrode forming process.

In the present embodiment, as described above, the thick film electrode forming process results in forming the thick film electrodes 31, 41 on the corresponding end faces 2a, 2b. The electroconductive thin film forming process, resist layer forming process, electroconductive thin film removing process, and resist layer peeling process result in forming the electroconductive thin film 51, or the thin film electrodes 32, 42 so as to cover the thick film electrodes 31, 41 and the respective partial regions of the two principal faces 2c, 2d and the two side faces 2e, 2f.

The thick film electrodes 31, 41 are formed on the corresponding end faces 2a, 2b. This configuration ensures electrical connection between the thick film electrode 31 and the internal electrodes 7, electrical connection between the thick film electrode 41 and the internal electrodes 8, and adherence strength of the thick film electrodes 31, 41 to the element body 2 at a necessary and sufficient level.

The thick film electrodes 31, 41 are formed substantially on the corresponding end faces 2a, 2b only. Portions of the thin film electrodes 32, 42 are formed on the respective partial regions of the two principal faces 2c, 2d and the two side faces 2e, 2f adjacent to the end faces 2a, 2b. This configuration drastically reduces the size of the portions of the external electrodes 3, 4 on the two principal faces 2c, 2d and the two side faces 2e, 2f of the element body 2. As a consequence, the electronic component 1 can be realized in a compact size.

The thick film electrodes 31, 41 and the thin film electrodes 32, 42 formed thereon are located on the end faces 2a, 2b of the element body 2. This configuration prevents a plating solution from infiltrating through the end faces 2a, 2b into the element body 2 during the formation of each of the plated layers 33, 34, 43, 44. Therefore, it can prevent degradation of characteristics of the electronic component 1.

The thin film electrodes 32, 42 are comprised of tungsten. Tungsten is an electroconductive material easy to oxidize and highly adhesive to the element body 2 comprised of oxide. Therefore, the thin film electrodes 32, 42 strongly adhere to the element body 2 at the portions thereof located on the two principal faces 2c, 2d and on the two side faces 2e, 2f, so as to ensure the adherence strength of the thin film electrodes 32, 42 to the element body 2. Tungsten is also the electroconductive material resistant to corrosion with the plating solution. Therefore, it can suppress corrosion of the thin film electrodes 32, 42 due to the plating solution during the formation of each of the plated layers 33, 34, 43, 44.

The thin film electrodes 32, 42 of tungsten function to prevent solder leach of the thick film electrodes 31, 41 and to prevent reaction between solder and thick film electrodes 31, 41 in the mounting operation. For this reason, the film thickness of the first plated layers 33, 43 may be extremely small. The external electrodes 3, 4 may be constructed without the first plated layers 33, 43 of Ni or the Ni alloy. In this case, the plated layer forming process is to form the second plated layers 34, 44 of Sn or the Sn alloy on the surfaces of the thin film electrodes 32, 42 as seed layers. Either of the above configurations can reduce requirements and cost for the plating process.

The film thickness of the thin film electrodes 32, 42 is not less than 0.005 μm and not more than 2 μm and is more preferably not less than 0.01 μm and not more than 0.2 μm. This configuration can more drastically reduce the size of the external electrodes 3, 4. Even if the film thickness of the thin film electrodes 32, 42 is not more than 0.2 μm, the thin film electrodes 32, 42 will fully function as seed layers in the formation of each of the plated layers 33, 34, 43, 44. Since the film thickness of the thin film electrodes 32, 42 can be extremely small, it is easy to form the thin film electrodes 32, 42, which can reduce production requirements and cost.

The electroconductive thin film forming process results in making the electroconductive thin film 51 of tungsten. Since tungsten is the material highly adhesive to the element body 2 as described above, it has high adhesion to the element body 2 and ensures the adherence strength of the electroconductive thin film 51 to the element body 2 at a necessary and sufficient level. Since tungsten is the material resistant to corrosion with the plating solution, it can suppress the corrosion of the electroconductive thin film 51 (thin film electrodes 32, 42) due to the plating solution used in the plated layer forming process. Since tungsten is the electroconductive material that can be dry-etched, the electroconductive thin film removing process can be carried out by applying a dry etching process, especially a plasma etching process. This process allows simple and easy removal of the electroconductive thin film 51.

The reactive ion etching (RIE: Reactive Ion Etching) process is known as one of dry etching processes. The RIE process is anisotropic etching, while the plasma etching process is isotropic etching. If the RIE process is used to remove the electroconductive thin film 51, etching has to be executed face by face, which makes the step complicated. In contrast to it, when the electroconductive thin film 51 is removed by the plasma etching process, the barrel type plasma etching system can be used and the multiple faces can be etched together. Accordingly, the plasma etching process is superior in efficiency to the RIE process.

Besides tungsten, the material of the electroconductive thin film 51 (thin film electrodes 32, 42) can also be Mo, Nb, Ta, Ti, or Zr as described above. Since the materials other than tungsten are inferior in dry etching performance, it becomes necessary to use a Cl-based gas or a Br-based gas as the etching gas or to perform the etching by the RIE process. Therefore, tungsten is preferred as the material of the electroconductive thin film 51 (thin film electrodes 32, 42).

In the electroconductive thin film forming process, the film thickness of the electroconductive thin film 51 is not more than 0.2 μm. Even in the case where the film thickness of the electroconductive thin film 51 is not more than 0.2 μm, the electroconductive thin film 51 fully functions as a seed layer in the formation of the first plated layers 33, 43. Since the film thickness of the electroconductive thin film 51 can be extremely small, it is easy to form the electroconductive thin film 51, which can reduce the production requirements and cost. In removing the electroconductive thin film 51 not covered by the resist layers 53, the electroconductive thin film 51 can be removed in a short time because it is thin.

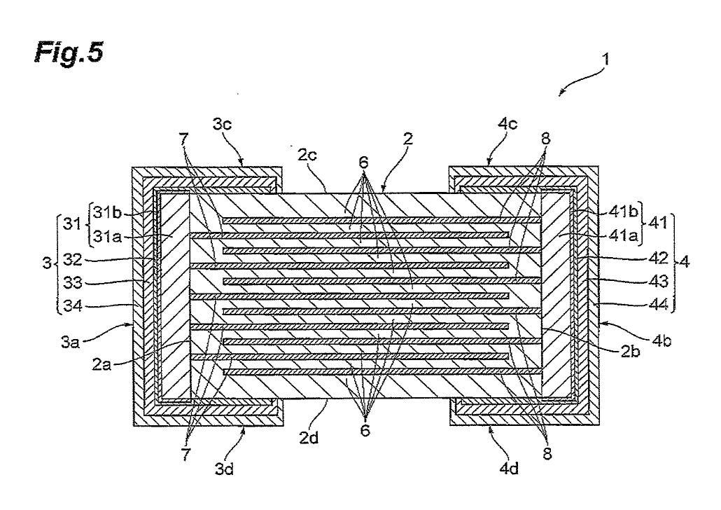

The below will describe a configuration of the electronic component 1 according to a modification example of the embodiment, with reference to FIG. 5. FIG. 5 is a drawing for explaining the sectional configuration of the electronic component according to the modification example of the embodiment. The present modification example is different in the external electrodes 3, 4 and, particularly, in the configuration of the thick film electrodes 31, 41 from the aforementioned embodiment.

Bach of the thick film electrodes 31, 41 has, as shown in FIG. 5, a sintered electrode layer 31a, 41a and a plated layer 31b, 41b formed on the sintered electrode layer 31a, 41a, respectively. Namely, each thick film electrode 31, 41 is a complex layer of the sintered electrode layer 31a, 41a and the plated layer 31b, 41b. In the same manner as the aforementioned thick film electrode forming process, the electroconductive paste is applied to the element body 2 and the applied electroconductive paste is sintered to form the sintered electrode layers 31a, 41a. The plated layers 31b, 41b are formed so as to cover the surfaces of the sintered electrode layers 31a, 41a.

When the electroconductive paste is applied onto the end faces 2a, 2b of the element body 2, the applied electroconductive paste rises in regions corresponding to the central portions of the end faces 2a, 2b of the element body 2 because of its surface tension. For this reason, the sintered electrode layers formed by sintering of the applied electroconductive paste tend to have non-uniform thickness. In contrast to it, it is easy to form films of plated layers in uniform thickness. Therefore, when the sintered electrode layers 31a, 41a are formed in small thickness and the plated layers 31b, 41b are further deposited thereon, the thick film electrodes 31, 41 can be formed in more uniform thickness.

The plated layers 31b, 41b are preferably plated layers comprised of the same metal component as that making up the sintered electrode layers 31a, 41a. For example, when the sintered electrode layers 31a, 41a are comprised of the metal component of Cu, it is preferable to make the plated layers 31b, 41b of the metal component of Cu as well. In the process of forming the plated layers 31b, 41b, it is preferable to perform a thermal treatment after the formation of the plated layers 31b, 41b, and it is more preferable to perform a thermal treatment in an oxidizing atmosphere and then perform an additional thermal treatment in a reducing atmosphere. The plated layers 31b, 41b after subjected to the foregoing thermal treatment (additional thermal treatment) are formed as dense films when compared to plated layers not subjected to oxidation-reduction processes, and become completely integrated with the sintered electrode layers 31a, 41a. For this reason, it is feasible to more effectively prevent the plating solution from penetrating into the element body 2.

The above described the preferred embodiments of the present invention, but it should be noted that the present invention is not always limited to the foregoing embodiments but may be modified in various ways without departing from the spirit and scope of the invention.

The embodiment showed the example of the multilayer ceramic capacitor as the electronic component, but the present invention, which does not have to be limited to it, can also be applied to other electronic components such as multilayer inductors, multilayer varistors, multilayer piezoelectric actuators, multilayer thermistors, or multilayer composite components. Particularly, in the case of the multilayer ceramic capacitor, reliability of the component will considerably degrade if a wet etching solution such as an acid or an alkali penetrates into the element body 2. Therefor the effect of application of the present invention is significant to the multilayer ceramic capacitor. In the case of electronic components using semiconductor ceramics such as multilayer varistors or multilayer thermistors, the element body is readily corroded with an etchant such as an acid or an alkali. Therefore, the effect of application of the present invention is also significant to the electronic components using semiconductor ceramics.

The embodiment showed the example of the electronic component 1 having the five-face electrode structure as the electronic component, but the present invention is not limited to it. For example, the same effect is also achieved with electronic components having a three-face electrode structure or a two-face electrode structure, like chip resistors. In the three-face electrode structure, the external electrodes 3, 4 are not formed either on the side faces 2e, 2f or on the principal faces 2c, 2d of the element body 2. In the two-face electrode structure, the external electrodes 3, 4 are formed on the end faces 2a, 2b, and on only any one of the side faces 2e, 2f and the principal faces 2c, 2d. The same effect is also achieved with electronic components having multi-terminal external electrodes, such as multilayer capacitor arrays and chip type three-terminal feedthrough multilayer capacitor arrays.

From the invention thus described, it will be obvious that the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An electronic component comprising:
an element body having a pair of end faces opposed to each other, a pair of principal faces extending so as to connect the pair of end faces and opposed to each other, and a pair of side faces extending so as to connect the pair of principal faces and opposed to each other; and
an external electrode arranged on the element body and formed so as to cover the end face and a partial region of the principal face and/or a partial region of the side face,
wherein the external electrode has:
a thick film electrode formed on the end face;
a thin film electrode formed so as to cover the thick film electrode and the partial region of the principal surface and/or the partial region of the side face; and
a plated layer formed outside the thin film electrode and containing Sn or an Sn alloy.

2. The electronic component according to claim 1,
wherein the thin film electrode is comprised of tungsten.

3. The electronic component according to claim 1,
wherein the film thickness of the thin film electrode is not more than 0.2 μm.

4. The electronic component according to claim 1,
wherein the thick film electrode has a sintered electrode layer and a plated layer formed on the sintered electrode layer.

5. A method for manufacturing an electronic component, comprising:
an element body preparation step of preparing an element body having a pair of end faces opposed to each other, a pair of principal faces extending so as to connect the pair of and faces and opposed to each other, and a pair of side faces extending so as to connect the pair of principal faces and opposed to each other; and
an external electrode forming step of forming an external electrode so as to cover the end face and a partial region of the principal face and/or a partial region of the side face, on the element body,
wherein the external electrode forming step includes:
a step of forming a thick film electrode on the end face;
a step of forming an electroconductive thin film on the thick film electrode and on the principal face and/or the side face by a vacuum film formation method;
a step of forming a resist layer on an intended area of formation of the external electrode on the electroconductive thin film;
a step of removing the electroconductive thin film not covered by the resist layer, by an etching method;
a step of peeling off the resist layer; and
a step of forming a plated layer containing Sn or an Sn alloy, after peeling off the resist layer.

6. The method according to claim 5,
wherein the step of forming the electroconductive thin film comprises forming the electroconductive thin film of tungsten.

7. The method according to claim 5,
wherein the step of forming the electroconductive thin film comprises forming the electroconductive thin film in the film thickness of not more than 0.2 μm.

8. The method according to claim 5,
wherein the step of forming the thick film electrode comprises forming a sintered electrode layer by sintering of an electroconductive paste, and forming a plated layer on the sintered electrode layer.
